(19) United States
(12) Patent Application Publication
(10) Pub. No.: US 2017/0081965 A1
(43) Pub. Date: Mar. 23, 2017

(54) TURBOENGINE COMPONENT AND METHODS FOR ASSEMBLING AND RECONDITIONING A TURBOENGINE COMPONENT

(71) Applicant: ANSALDO ENERGIA IP UK LIMITED, London (GB)

(72) Inventors: Herbert BRANDL, Waldshut-Tiengen (DE); Joergen FERBER, Wutoschingen (DE)

(73) Assignee: ANSALDO ENERGIA IP UK LIMITED, London (GB)

(21) Appl. No.: 15/272,042

(22) Filed: Sep. 21, 2016

(30) Foreign Application Priority Data
Sep. 22, 2015 (EP) 15186312.3

(51) Int. Cl. F01D 5/30; F01D 25/08; F01D 9/02

(52) U.S. Cl. CPC F01D 5/303; F01D 9/02; F01D 25/08; F05D 2220/30; F05D 2260/30

(57) ABSTRACT

A turboengine component is disclosed, having at least one first, receiving, member and at least one second, received, member, the receiving member having at least one receiver opening, the received member including a body and at least one fixation post extending from the body. A retainer cavity is provided with a first retainer groove at an inner surface of the receiver opening. A second retainer groove is provided on a surface of the fixation post. A retainer member has a cross section and a longitudinal extent aligned with the lengthwise extent of the retainer cavity, the retainer member being displaceable within the retainer cavity along the lengthwise extent. The retainer member may be removed and the turboengine component may be disassembled without the damaging any of the received member and the receiving member.

### TECHNICAL FIELD

The present disclosure relates to a turboengine component as set forth in claim 1, and further a method for reconditioning a turboengine component as further set forth below. Further, a method for assembling and interlocking a turboengine component is disclosed.

### BACKGROUND OF THE DISCLOSURE

It is known in the art to provide turboengine components, such as for instance blading members, assembled from at least one received member and at least one receiving member. In particular, the receiving member may be a platform member and the received member may be an airfoil member. In said instance, an airfoil member comprises an airfoil, in a manner known to the person having skill in the art, having a spanwidth extending between a bade and a tip of the airfoil, a leading edge, a trailing edge, and a suction side and a pressure side. The suction side, at least for airfoils intended to be used in connection with subsonic working fluid flows along the airfoil profile, extends convexly from the leading edge to the trailing edge while the pressure side extends concavely from the leading edge to the trailing edge. In the case of airfoils intended for transonic or supersonic flow conditions the pressure side and the suction side may be contoured differently, however, the skilled person will readily appreciate which side is the pressure side and the suction side. Thus, a pressure side and a suction side of the airfoil member are defined. The airfoil member further comprises at least one fixation post provided at at least one of the base and the tip of the airfoil. The fixation post is received in a receiver opening of the platform member, and the airfoil member and the platform member are connected to each other, in particular are interlocked, and a joint is formed between the fixation post and the platform member inside the receiver opening.

A blading member may comprise one or more airfoil members. A platform member may be disposed at a base of the airfoil or at a tip of the airfoil, or both.

Providing the turboengine component as an assembled turboengine component inhibits various benefits. For instance, in a turboengine blading member, providing the airfoil member and the platform member as distinct individual members inhibits various benefits. For instance, a worn blading member may be disassembled, and an airfoil member and a platform member may be replaced or reconditioned individually. For another instance, the blading member may be obtained from a directional solidification process, while a more cost effective process and/or a material may be used for the platform member. Moreover, it is noted that in assembling the blading member from individual members, smaller individual members with more uniform cross sections are required, which facilitates processing, such as for instance casting and coating. Further, a higher flexibility in machining the individual members is achieved, as tooling access to an airfoil member is not impeded by a platform, and vice versa.

It may, in the instance of a turboengine blading member, be found desirably to provide a detachable interlock between the airfoil member and the platform member, facilitating disassembling the blading member if reconditioning is required. Moreover, choosing different materials for the airfoil member and the platform member may result in different thermal expansion coefficients being present for both members. A rigid joint of platform and airfoil members may thus result in high stresses induced at the joint due to mismatch in thermal expansion.

It may, in a more general context, be desirable to provide said detachable interlock for any other type of an assembled turboengine component.

EP 1 176 284 proposes a braze connection of airfoil and platform members.

US 2012/0009071, U.S. Pat. No. 7,686,571 and U.S. Pat. No. 7,704,044 each teach providing retainer grooves in the receiver cavity and on the fixation post and inserting a wire or pin as a retainer member into the jointly formed retainer cavity. However, the methods and devices disclosed therein require an external access to the retainer cavity, from an external surface of the platform member. Appropriate access ports thus need to be provided from an external surface of the platform member and through the platform member and joining the retainer cavity. A retainer cavity thus needs to be provided which is open on an outer surface of the platform member.

US 2009/0196761 and U.S. Pat. No. 5,797,725 each teach preparing the retainer member in situ inside a retainer cavity, wherein a retainer cavity is jointly formed by a retainer groove provided on the fixation post and a retainer groove formed inside the receiver cavity, in molding a liquid casting slip into the retainer cavity and solidifying the casting slip inside the retainer cavity. The casting slip is chosen such that material bonding with the respective members to be interconnected is avoided. The retainer cavity may in particular exhibit a cross section and a lengthwise extent, wherein the lengthwise extent further in particular runs around a circumferential extent of the joint between the platform member and the fixation post and inside the receiver opening, or at least essentially perpendicular to an axis of the receiver cavity, respectively. It may, in another aspect, be said that the longitudinal extent of the retainer cavity is in particular oriented at least essentially perpendicular to the spanwidth extent of the airfoil, or at least in particular perpendicular to an orientation form a coolant side of the platform member to a working fluid exposed side of the platform member, respectively. In particular, the retainer cavity may form a closed loop spanning the circumferential extent of the airfoil member fixation post, along a pressure side, a leading edge, a suction side, and a trailing edge section thereof. A retainer member is thus formed inside the retainer cavity which snugly fits inside the retainer cavity, and as such a cross section of the retainer member matches the cross section of the retainer cavity in each cross section of the retainer cavity for each cross section taken along the lengthwise extent of the retainer cavity, or along a longitudinal extent of the retainer member, respectively. Alignment mismatch of the retainer grooves forming the retainer cavity poses no problem in placing the retainer member, as would be the case in the art cited above. However, as the retainer member is formed in a closed retainer cavity, there may be some difficulty in releasing the interlock between the individual members of the blading member, for instance for blading member reconditioning purposes.

### LINEOUT OF THE SUBJECT MATTER OF THE PRESENT DISCLOSURE

It is an object of the present disclosure to provide an assembled turboengine component comprising at least one received member and at least one receiving member, of the kind initially mentioned. In another aspect, it is an object of the present disclosure to enable releasing the interlock between a received member and a receiving member. In particular, an aspect of the present disclosure may be seen in providing the turboengine component without any openings of the retainer cavity at an external surface of the receiving member, which could potentially cause a fluid at elevated temperature, in particular hot working fluid, to be ingested therein. In the more particular context of a turboengine blading member, an aspect of the present disclosure may be seen in providing the blading member without any openings of the retainer cavity at an external surface of the platform member. This may be found desirable in applying in situ prepared retainer members for interlocking the receiving member and the received member, as disclosed for instance in U.S. Pat. No. 5,797,725 and 2009/0196761. In said instances, the integrity of the interlock may be compromised if the in situ prepared retainer member overheats, which may be the case if hot working fluid is ingested into the retainer cavity, which may be the case if the retainer cavity is open at an external surface of the receiving member. A further object of the presently disclosed subject matter may accordingly be seen in disclosing an assembled turboengine component in which the retainer member has been prepared in situ. In a more specific aspect, the retainer member may have been prepared according to the teaching of U.S. Pat. No. 5,797,725, or according to the teaching of US 2009/0196761, respectively, the respective disclosure thereof being included herein by reference.

Further, a method for easy reconditioning an accordingly provided turboengine component is disclosed.

Further a method for assembling and interlocking individual receiving and received members to obtain a turboengine component as herein described is disclosed.

This is achieved by the subject matter set forth in claim 1 and by the subject matter disclosed in the further independent claims.

Further effects and advantages of the disclosed subject matter, whether explicitly mentioned or not, will become apparent in view of the disclosure provided below.

Accordingly, a turboengine component is disclosed, comprising at least one first, receiving, member and at least one second, received, member. In other words, a turboengine component is disclosed which is assembled from a received member and a receiving member. The receiving member comprises at least one receiver opening, and the received member comprises a body. At least one fixation post extends from the body. The fixation post is received in a receiver opening of the received member and forms a joint with the received member inside the receiver opening. At least one retainer cavity is formed at the joint. The retainer cavity is comprised of at least one first retainer groove provided at an inner surface of the receiver opening and at least one second retainer groove provided on a surface of the fixation post. The retainer cavity has a cross section and a lengthwise extent, and a retainer member is provided in the retainer cavity, providing an interlock between the receiving member and the received member. The retainer member has a cross section and a longitudinal extent, and the longitudinal extent of the retainer member is aligned with the lengthwise extent of the retainer cavity. The retainer cavity is open at two front faces, and the lengthwise extent of the retainer cavity extends between said two open front faces. The retainer cavity is arranged and configured such that the retainer member is displaceable within the retainer cavity along the lengthwise extent of the retainer cavity. The open front faces of the retainer cavity are provided at the joint of the fixation post and the receiving member.

In an aspect, the turboengine component may be a component intended for use in the working fluid path of a turboengine. The turboengine component may be a component intended for use in the hot gas path of an internal combustion turboengine. In an even more specific aspect, the turboengine component may be a component intended for use in the hot gas path of an expansion turbine of an internal combustion turboengine. In a further more specific aspect, the turboengine component may be a component intended for use in the combustion chamber of an internal combustion turboengine. In still further more specific aspects, the turboengine component may be one of a blading member and a stator or rotor heat shield, and may more particularly be intended for use in an expansion turbine of an internal combustion turboengine.

Hence, in a more specific instance, a turboengine blading member is disclosed, comprising at least one platform member and at least one airfoil member. In other words, a turboengine blading member is disclosed which is assembled from an airfoil member and a platform member. The platform member comprises at least one receiver opening, and the airfoil member comprises an airfoil extending from a base to a tip. At least one fixation post is provided on at least one of the base and/or the tip of the airfoil. The fixation post is received in a receiver opening of the platform member and forms a joint with the platform member inside the receiver opening. At least one retainer cavity is formed at the joint. The retainer cavity is comprised of at least one first retainer groove provided at an inner surface of the receiver opening and at least one second retainer groove provided on a surface of the fixation post. The retainer cavity has a cross section and a lengthwise extent, and a retainer member is provided in the retainer cavity, providing an interlock between the airfoil member and the platform member. The retainer member has a cross section and a longitudinal extent, and the longitudinal extent of the retainer member is aligned with the lengthwise extent of the retainer cavity. The retainer cavity is open at two front faces, and the lengthwise extent of the retainer cavity extends between said two open front faces. The retainer cavity is arranged and configured such that the retainer member is displaceable within the retainer cavity along the lengthwise extent of the retainer cavity. The open front faces of the retainer cavity are provided at the joint of the fixation post and the platform member.

Due to the manner in which the retainer cavity is arrangement and provided, it is possible to displace a retainer member provided inside a retainer cavity at least partially out of the retainer cavity through one of the open front faces. The extent of the retainer cavity is restricted to the receiver opening, or the joint interface, respectively. In contrast to some of the art cited above, no access from a side surface of the receiving member, for instance a platform member, is required nor provided. The retainer cavity does not extend to a side wall of the receiving member, or the platform member, respectively. One exemplary benefit may be seen in the fact that the open front faces of the retainer cavity are provided at the joint interface, which commonly is purged with coolant. Thus, it is reliably avoided to charge the interior of the retainer cavity, or the retainer member provided therein, respectively, with hot working fluid, but with a coolant. Thus, no specific requirements are present as to the high temperature resistance of the retainer member. Another benefit may be seen at the fact that for another instance the retainer member is not subjected to potentially corrosive high temperature combustion gases in the expansion turbine of an internal combustion turboengine. It is thus avoided that the retainer member could seize up inside the retainer cavity, which in turn would impede removal of the retainer member for disassembling the turboengine component.

To that extent it is appreciated that the disclosed turboengine component, or, for a more specific instance, blading member, is particularly suitable with an in situ prepared retainer member as lined out above. In that respect, a turboengine component, or, for a more specific instance, turboengine blading member, is disclosed wherein the retainer member is an in situ prepared and in particular in situ molded retainer member, for instance as disclosed in some of the art cited above, and in particular as disclosed in U.S. Pat. No. 5,797,725. In another aspect the turboengine component is disclosed with the retainer member being prepared in molding a liquid casting slip into the retainer cavity and solidifying the liquid casting slip inside the retainer cavity.

In certain aspects, the receiving member may comprise a coolant side and a working fluid exposed side, while the body of the received member may be arranged on the working fluid exposed side. It is understood that the coolant side is exposed to a relatively lower temperature than the working fluid exposed side. In the instance of a turboengine balding member, it is known to the skilled person that the platform member comprises a coolant side and a working fluid exposed side, and an airfoil is arranged on the working fluid exposed side. It may hence be said that also the turboengine component comprises a coolant side and a working fluid exposed side. The interlock feature, comprising at least one retainer cavity and a retainer member provided therein, may be arranged at a certain distance from the working fluid exposed side and towards the coolant side.

The fixation post and the receiver opening are, according to an aspect of the presently disclosed turboengine component, arranged and configured such as to allow access to the front faces of the retainer cavity from within the receiver opening, or from the coolant side, respectively, and a space is provided inside the receiver opening at least adjacent one of the front faces which enables the retainer member to be at least partially displaced from the retainer cavity into said space by a displacement along the lengthwise extent of the retainer cavity. The retainer member may be stepwise displaced out of the retainer cavity and into said space. The space may in one instance be sufficient to displace the entire retainer member into the space and remove it from there in one piece. In another instance, the space may be insufficient for said displacement. In said instance, the retainer member may be partially displaced into said space, the section protruding into the space may be cut and removed, and the retainer member may subsequently be further displaced into the space. This may be repeated until the entire retainer member has been removed. It will be readily appreciated that in said instance it will not be possible to introduce a pre-manufactured retainer member into the retainer cavity as there would be insufficient space provided. Removal of the retainer member may however be easily performed in subsequent displacement, cutting and removal steps. In that respect, the turboengine component is particularly designed to be assembled in preparing the retainer member in situ, as comprehensively described above, and in this respect a turboengine component and in certain instances a blading member is implicitly disclosed in which the retainer member has been prepared in situ. In another aspect, a turboengine component and in certain instances a blading member in which a retainer member has been mandatorily prepared in situ is disclosed.

Within the frame of the present disclosure, a lengthwise or longitudinal extent is to be understood as not being limited to an extent along a straight line. It will however be understood that the retainer member and the retainer cavity have a crosswise extent forming a cross section, and one extent which is substantially greater, for instance by a factor of two and more, than any crosswise extent. Said longer extent will readily be understood as the lengthwise or, respectively, longitudinal extent. Said lengthwise or, respectively, longitudinal extent can in essence take any shape as long as a displacement of the retainer member along the lengthwise extent of the retainer cavity is enabled. In particular, the retainer member is displaceable at least in one direction along the entire lengthwise extent of the retainer cavity such as to be displaced out of the retainer cavity through at least one of the open front faces. In certain more specific embodiments of the herein described turboengine component the lengthwise extent of the retainer cavity extends along one of an at least essentially straight or circular line.

In certain aspects of the turboengine component as herein disclosed at least one of the retainer cavity and the retainer member tapers unidirectionally along the lengthwise or longitudinal extent, respectively. It is understood that the displacement of the retainer member inside the retainer cavity in this instance is enabled in one direction only, that is, in a direction opposite to the tapering direction. In other instances, however, the cross sections of the retainer member and/or the retainer cavity may be constant along the entire lengthwise or longitudinal extent, respectively.

In certain aspects, the cross sections of the retainer member and/or the retainer cavity may be one of circular, elliptic, oval, square, hexagonal, triangular, or otherwise polygonal shaped, or a combination thereof.

The retainer member may be locked inside the common retainer cavity, wherein the lock is detachable. In particular embodiments the lock may be detachable in applying a force on the retainer member on a front face thereof while maintaining structural integrity of the receiving member and the received member. This may for instance be achieved in that the locking connection is provided by a form lock feature. In particular a male form lock feature may be provided on the retainer member and be received in an undercut provided at a wall of the retainer cavity. The form lock feature may be arranged and configured to be detachable by means of a predetermined breaking point provided joint of the retainer member and the from lock feature. That is, a junction of the retainer member and the form lock feature inhibits less structural strength than any of the receiving member and the received member. Upon removal of the retainer member, the retainer member may be destroyed, while the received member and/or the receiving member remain intact and may be reused, if appropriate after reconditioning, for instance recoating. Reverting to the in situ preparation of the retainer member, the form lock feature may be provided by a fraction of the solidified casting slip which is contained inside a mold access port through which the casting slip is mold into the retainer cavity. The mold access port may be tapering towards the retainer opening, or form a neck at a junction therewith, thus providing for the predetermined breaking point between the retainer member and the from lock feature. In preparing the retainer member in situ by a molding process as lined out above, essentially any undercut of the retainer member with the received member and/or the receiving member inside the retainer cavity may be prepared as a form lock feature. Again, benefits of applying in situ preparation of the retainer member as a non-reusable element come into play.

The form lock feature may further be removed by a material removing process, for instance a milling process.

Each cross section of the retainer member may in certain embodiments exactly match a corresponding cross section of the retainer cavity in which it is received along the entire longitudinal extent of the retainer member, such that the retainer member snugly fits inside the retainer cavity. It goes without saying that this is inherent to an in situ preparation of the retainer member, in particular in appropriately applying a molding process to prepare the retainer member.

To enable in situ preparation of the retainer member, a mold access port is provided in fluid communication with the retainer cavity, the mold access port being arranged between the front faces of the retainer cavity and transverse to the retainer cavity lengthwise extent in certain embodiments of the herein disclosed turboengine component, such as to allow the retainer member to be prepared in situ by a mold process inside the retainer cavity. In particular, the mold access port may be arranged at least essentially in the middle of the lengthwise extent of the retainer cavity, which may be found desirable for the molding process.

The turboengine component according to the present disclosure may be characterized in that at least two retainer cavities with retainer members provided therein are provided at the joint of the fixation post and the receiving member inside the receiver opening. For instance, at least two retainer cavities with a retainer member provided therein may be disposed on opposite sides of the fixation post. For a more specific instance, at least one retainer cavity with a retainer member provided therein may be disposed on a suction side of the airfoil member and at least one retainer cavity with a retainer member provided therein may disposed on a pressure side of the airfoil member.

All retainer cavities and all retainer members may in specific embodiments exhibit one or more of the respective features lined out above.

In instances of the turboengine component, at least two retainer cavities with retainer members provided therein are disposed at the joint of the fixation post and the receiving member inside the receiver opening, wherein said at least two retainer cavities are provided with the respective cross sections offset with respect to one another on an inner wall of the receiver opening and on the fixation post in a direction across the lengthwise extent of a retainer cavity, and in particular along a direction oriented from a coolant side of the receiving member to a working fluid disposed side of the receiving member, such that the cross sections of said retainer cavities are provided without a cross sectional overlap. In instances of the blading member, at least two retainer cavities with retainer members provided therein are disposed at the joint of the fixation post and the platform member inside the receiver opening, wherein said at least two retainer cavities are provided with the respective cross sections offset with respect to one another on an inner wall of the receiver opening and on the fixation post along a direction oriented from a coolant side of the platform member to a working fluid disposed side of the platform member, such that the cross sections of said retainer cavities are provided without a cross sectional overlap. Thus, the retainer cavities are provided such that the removal of the retainer members is not impeded.

In further instances, a multitude of retainer cavities with retainer members provided therein are provided at the joint between the fixation post and the receiving member inside the receiver opening, wherein each pair of neighboring retainer cavities are provided with the respective cross sections offset with respect to one another on an inner wall of the receiver opening and on the fixation post along a direction oriented across the lengthwise extent of a retainer cavity, along a direction oriented from a coolant side of the receiving member to a working fluid disposed side of the receiving member, such that the cross sections of each pair of neighboring retainer cavities are provided without a cross sectional overlap. In more specific instances, a multitude of retainer cavities with retainer members provided therein are provided at the joint between the fixation post and a platform member inside the receiver opening, wherein each pair of neighboring retainer cavities are provided with the respective cross sections offset with respect to one another on an inner wall of the receiver opening and on the fixation post along a direction oriented from a coolant side of the platform member to a working fluid disposed side of the platform member, such that the cross sections of each pair of neighboring retainer cavities are provided without an overlap.

In said instances, the individual retainer cavities and/or retainer members may be provided to jointly form a closed loop when seen in a projection from a coolant side to a working fluid disposed side of the receiving member, or, in another aspect seen along an axis of the receiver opening or the fixation post, respectively. This enables to provide an at least essentially gas-tight sealing at the joint interface of the receiving member and the received member.

It is noted that in particular, in said cases with two or more retainer cavities being provided with a cross sectional offset, the retainer cavities may be arranged with their respective lengthwise extents in parallel offset planes.

Further, in said instances, the retainer cavities and the retainer members may in more specific embodiments overlap each other in their lengthwise and/or longitudinal directions.

In another aspect of the present disclosure, a method of reconditioning a turboengine component is disclosed. The turboengine component comprises at least one first, receiving, member and at least one second, received, member. The receiving member comprises a receiver opening. The received member comprises a body and at least one fixation post extending from said body. The fixation post is received in a receiver opening and forming a joint with the receiving member inside the receiver opening, wherein at least one retainer cavity is formed at the joint. The retainer cavity is comprised of at least one first retainer groove provided at an inner surface of the receiver opening and at least one second retainer groove provided on a surface of the fixation post. The retainer cavity has a cross section and a lengthwise extent, and a retainer member is provided in the retainer cavity, the retainer member having a cross section and a longitudinal extent. The longitudinal extent of the retainer member is aligned with the longitudinal extent of the retainer cavity.

In a more specific aspect, a method of reconditioning a turboengine blading member is disclosed. The blading member comprises at least one platform member and at least one airfoil member. The platform member comprises a receiver opening. The airfoil member comprises an airfoil extending from a base to a tip and at least one fixation post provided on at least one of the base and/or the tip. The fixation post is received in a platform receiver opening and forming a joint with the platform member inside the receiver opening. At least one retainer cavity is formed at the joint, the retainer cavity being comprised of at least one first retainer groove provided at an inner surface of the receiver opening and at least one second retainer groove provided on a surface of the fixation post. Said retainer cavity exhibits a cross section and a lengthwise extent. A retainer member is provided in the retainer cavity, the retainer member exhibiting a cross section and a longitudinal extent, wherein the longitudinal extent of the retainer member is aligned with the longitudinal extent of the retainer cavity.

It will be readily appreciated that in certain aspects the turboengine component, and, in more specific aspects the blading member, is a turboengine component, and in more specific aspects a blading member, as disclosed above.

The method comprises accessing an open front face of a retainer cavity provided inside the receiver opening, accessing the open front face from within the receiver opening, applying a pushing force on the retainer member from said open front face of the retainer cavity, thus displacing the retainer member inside the retainer cavity and at least partially out of the retainer cavity at a second open front face of the retainer cavity, removing the retainer member, and disassembling the receiving member and the received member. Embodiments of the method are conceivable in which the retainer member is only partially pushed out of the retainer cavity in an initial step. This may be the case, for instance, due to space restrictions adjacent the open front face of the retainer cavity through which the retainer member is displaced out of the retainer cavity. The projecting section of the retainer member may then be cut and removed. Subsequently, the retainer member may be further pushed out of the retainer cavity. Said steps may be repeated until the retainer member is completely removed.

The method comprises in the more specific aspects accessing an open front face of a retainer cavity provided inside the receiver opening and accessing the open front face from within the receiver opening. A pushing force is applied on the retainer member from said open front face of the retainer cavity, thus displacing the retainer member inside the retainer cavity and at least partially out of the retainer cavity at a second open front face of the retainer cavity. The retainer member is then removed and the platform member and the retainer member are disassembled. Embodiments of the method are conceivable in which the retainer member is only partially pushed out of the retainer cavity in an initial step. This may be the case, for instance, due to space restrictions adjacent the open front face of the retainer cavity through which the retainer member is displaced out of the retainer cavity. The projecting section of the retainer member may then be cut and removed. Subsequently, the retainer member may be further pushed out of the retainer cavity. Said steps may be repeated until the retainer member is completely removed.

In certain instances, the turboengine component may be initially provided as a turboengine component according to the art, wherein the retainer member is provided inside a closed retainer cavity. In particular, the retainer member may be present as a closed clip spanning the entire circumference of the fixation post, and be provided in a retainer cavity spanning the entire circumference of the fixation post. The method may in this respect comprise an initial step of preparing the open front faces of the retainer cavity. To that extent, the method may comprise applying a material removing process at the joint between the received member and the receiving member, thus preparing an opening of the retainer cavity and providing an open front face of the retainer cavity inside the receiver opening. In particular the method may comprise applying multiple material removal processes such as to subdivide a closed, and in particular framing, retainer cavity, and retainer member enclosed therein, into a multitude of at least two retainer cavities with each comprising two open front ends. The retainer member sections inside these now opened retainer cavities may be removed as lined out above. The material removing, or cutting, steps may be applied such as to not essentially harm the structural integrity and structural strength of the receiving and/or received member to an extent such that it becomes or they become unusable. As those cuts are performed only at the joint interface and consequently on a coolant side of the receiving member, the aerodynamic properties for the working fluid are not affected. Furthermore, as only the respective open front faces of the retainer cavity need to be prepared, the material removal may be fairly limited, such as to preserve sufficient interlock lengths at the receiver opening and at the fixation post for again achieving a sufficiently strong interlock of a receiving member and a received member. In another instance the cut portions may be rebuilt during the reconditioning process. This may comprise for instance applying a laser based additive manufacturing with blown metal powder, e.g. Laser Metal Forming, Laser Metal Deposition.

In certain more specific instances, a blading member may be initially provided as a blading member according to the art, wherein the retainer member is provided inside a closed retainer cavity. In particular, the retainer member may be present as a closed clip spanning the entire circumference of the fixation post, and be provided in a retainer cavity spanning the entire circumference of the fixation post. The method may in this respect comprise an initial step of preparing the open front faces of the retainer cavity. To that extent, the method may comprise applying a material removing process at the joint between the airfoil member and the platform member, thus preparing an opening of the retainer cavity and providing an open front face of the retainer cavity inside the receiver opening. In particular the method may comprise applying multiple material removal processes such as to subdivide a closed, and in particular framing, retainer cavity, and retainer member enclosed therein, into a multitude of at least two retainer cavities with each comprising two open front ends. The retainer member sections inside these now opened retainer cavities may be removed as lined out above. The material removing, or cutting, steps may be applied such as to not essentially harm the structural integrity and structural strength of the airfoil and/or platform member to an extent such that it becomes or they become unusable. As those cuts are performed only at the joint interface and consequently on a coolant side of the blading member, the aerodynamic properties for the working fluid are not affected. Furthermore, as only the respective open front faces of the retainer cavity need to be prepared, the material removal may be fairly limited, such as to preserve sufficient interlock lengths at the platform member receiver opening and at the airfoil member fixation post for again achieving a sufficiently strong interlock of a platform member and an airfoil member.

For a re-assembly of the turboengine component, or the blading member, respectively, the method may further comprise providing at least one of a received member, or an airfoil member, respectively, and a receiving member, or a platform member, respectively. In particular, these may be at least one of the disassembled received member, or airfoil member, respectively, and receiving member, or platform member, respectively. The method further comprises providing a matching other one of a received member, or an airfoil member, respectively, and a receiving member, or a platform member, respectively. The receiving member and the received member are assembled in inserting a fixation post of the received member into a mating receiver opening of the receiving member and matching at least one retainer groove provided inside the receiver opening with at least one retainer groove provided on the fixation post, such as to jointly form a retainer cavity. In particular, said retainer cavity comprises two front faces and a lengthwise extent extending between said two open front faces. A liquid casting slip is subsequently molded into the retainer cavity and is solidified inside the retainer cavity, thus in situ preparing a retainer member inside the retainer cavity.

It is understood that both front faces of the retainer cavity may be provided as open front faces.

It is understood, that if a front face or both front faces of the retainer cavity are provided as open front faces, at least one of the front faces may be appropriately closed before the liquid casting slip is molded into the retainer cavity.

The molding process may comprise placing a closure member at at least one open front face of the retainer cavity. The liquid casting slip may then be cast into the retainer cavity through the other open front face. The method may further comprise removing the closure member after the casting slip is solidified. In other instances the closure member remains in place until the retainer member is removed from the retainer cavity. The closure may be placed and removed, for instance, along the lengthwise orientation of the retainer cavity or transverse thereto.

In other instances, the molding process may comprise placing a closure member at both open front faces of the retainer cavity. The liquid casting slip may then be cast into the retainer cavity through a mold access port being provided in communication with the retainer cavity. The mold access port may be provided transverse and in particular embodiments perpendicular to the lengthwise extent of the retainer cavity. The mold access port may be provided between the two open front faces, and in particular essentially in the middle between the two open front faces. The mold access port may be arranged and configured to provide a form lock feature of the retainer member therein after the casting slip is solidified. The mold access port may be arranged and configured such as to provide a predetermined breaking point of the form lock feature as lined out above, for instance, in that the mold access port tapers towards and/or comprises a neck at its junction with the retainer cavity.

A closure member may be provided as a plug or a closure port, and may be placed and removed, for instance, along the lengthwise orientation of the retainer cavity or transverse thereto.

A closure member may be a plug or other closure means. A closure member may be a retractable closure member. In other embodiments, a closure member may be screwed into the retainer cavity, or may be held in place by welding, for instance by spot welding. In the latter case, a cutting step will be required upon removal of the closure member.

The method may further comprise removing the closure members after the casting slip is solidified. In other instances the retractable closure members remain in place during component service, until the retainer member is removed from the retainer cavity.

It may be conceivable to close an open front face for instance by welding before the casting slip is molded or for another instance in applying a laser based additive process as mentioned above. The front faces may be re-opened, for instance by milling, after the casting slip is solidified, or may remain closed during component service until a disassembly of the component and thus removal of the retainer member is required.

Combinations of the above-mentioned mold process steps are readily conceivable.

It will be appreciated that a receiving member may comprise a single or two or more receiver openings. A received member may comprise a single or two or more fixation posts. In this respect, specific embodiments are conceivable wherein a blading member may comprise a single or two or more airfoils, and a platform may be provided at one or at both ends of an airfoil.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 an illustration of a fixation post of an airfoil member received in a receiver opening provided in a platform member, and interlocked with the platform member by retainer members provided in retainer cavities;

FIG. 2 a cross sectional view of the embodiment of FIG. 1, lining out the arrangement of retainer members;

FIG. 3 a schematic symbolization of a first mode of in situ preparing and removing a retainer member according to one aspect of the present disclosure;

FIG. 4 a schematic symbolization of a second mode of in situ preparing and removing a retainer member according to a further aspect of the present disclosure;

FIG. 5 a schematic symbolization of a further mode of in situ preparing and removing a retainer member according to yet another aspect of the present disclosure.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### EXEMPLARY MODES OF CARRYING OUT THE TEACHING OF THE PRESENT DISCLOSURE

Below, exemplary embodiments of the disclosed subject matter are disclosed. While the subject matter is disclosed by example of a turboengine blading member, the skilled person will readily appreciate applying the teaching provided herein to other turboengine components.

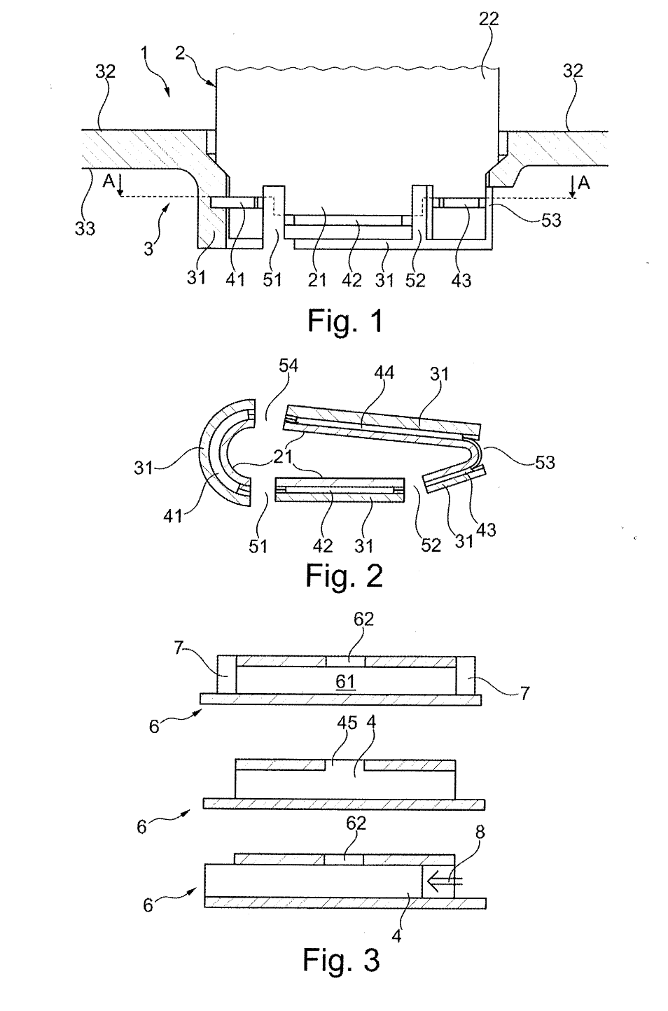

FIG. 1 shows a schematic partial view of an exemplary embodiment a turboengine blading member 1 which comprises an airfoil member 2 and a platform member 3. Platform member 3 exhibits a working fluid exposed side 32 and a coolant side 33. A collar 31 extends from the coolant side and comprises a receiver opening provided therein. The receiver opening is open on the working fluid exposed side of the platform to receive a fixation post 21 of airfoil member 2. A multitude of two or more individual fixation posts may be provided on an airfoil member for fixation to one platform member; accordingly the platform member may comprise a corresponding multitude of corresponding receiver openings. Airfoil member 2 furthermore comprises an airfoil 22 which extends from the working fluid exposed side of the platform. The receiver opening penetrates platform member 3, to allow access to a joint between the fixation post and the receiver opening. Platform member 3 is shown in a sectional view, to be able to visualize the arrangement and interlock of fixation post 21 in the receiver opening. In a manner generally known per se, retainer grooves are provided on fixation post 21 and on an inner surface of the collar 31 which bounds the receiver opening. The airfoil member and the platform member are arranged relatively to each other such that a pair of corresponding retainer grooves provided on the fixation post and provided inside the receiver opening match each other and jointly form a retainer cavity. Said position matching, in the presently shown embodiment, is provided by matching beveled shoulders provided inside the receiver cavity and on the airfoil member, which bear on each other. Said beveled shoulders may in particular extent all around the receiver opening and the airfoil member in a top view thereof, and jointly may in particular provide an at least essentially gas-tight sealing. For a full appreciation of the deliberations below, FIG. 1 needs to be considered in combination with FIG. 2. FIG. 2 shows a section along line A-A in FIG. 1. As becomes fully appreciated by virtue of FIG. 1 in combination with FIG. 2, fixation post 21 provided on airfoil member and collar 31 provided on the platform member are circumferentially segmented at one end thereof. Thus, a multitude of retainer cavities is formed, each retainer cavity having a cross section, two open front faces, and a lengthwise extent extending between the front faces. Retainer members 41, 42, 43 and 44 are provided in each retainer cavity. Each retainer member has a cross section corresponding to the cross section of the retainer cavity in which it is disposed. Each retainer member has a longitudinal extent which extends along the lengthwise extent of the respective retainer cavity. Each retainer member runs, along its longitudinal extent, along the lengthwise extent of the respective retainer cavity, and assumes a corresponding shape. Each retainer cavity and each therein disposed retainer member extend with their respective lengthwise or longitudinal extents either along an at least circular line or along an at least essentially straight line. Retainer members 41, 42, 43 and 44 are thus displaceable within the respective retainer cavity along the lengthwise extent of the respective retainer cavity, or, along the longitudinal extend of the retainer member. Each retainer member may thus be displaced through an open front face of the retainer cavity and at least partially out of the retainer cavity. Embodiments are conceivable, in which the lengthwise or longitudinal extents, respectively do not exactly follow a straight or circular line, if an access is provided to an open front face of a retainer cavity which allows to apply a sufficient pushing force on the respective retainer member to displace it inside and out of the respective retainer cavity, and/or the respective retainer member is provided with sufficiently low bending stiffness across the displacement direction. Reverting to FIG. 1 it is seen that each pair of neighboring retainer cavities and consequently each pair of neighboring retainer members provided therein are offset with respect to one another on the inner wall of the receiver opening and on the fixation post. That is, retainer member 41 is provided with an offset to retainer member 42, such that their cross-sections, and also the cross sections of the respective retainer cavities, do not overlap. Retainer member 42 is provided with an offset to retainer member 43, such that their cross-sections, and also the cross sections of the respective retainer cavities, do not overlap. Although not visible in the depiction of FIG. 1, it becomes apparent that also retainer member 44 is provided with an offset with respect to retainer member 41, such that their cross-sections do not overlap. Further, spaces 51, 52, 53 and 54 are provided between the circumferential segments of collar 31 and fixation post 21. These spaces may serve as access ports to the open front faces of the retainer cavities. Through these spaces or access ports an appropriate tool may be inserted to apply a pushing force through one open front faces of a retainer cavity and at one end of the therein provided retainer member, thus displacing the retainer member along the lengthwise extent of the retainer cavity and out of the retainer cavity through the other open front face, and into the space provided adjacent the other open front face of the retainer cavity. In that it is possible to displace the retainer members within the retainer cavities, they may either be removed in one piece, if sufficient space is provided, or to displace them partially out of the respective retainer cavity, cut the protruding section of a retainer member, remove the cut section, displace the retainer member further out of the retainer cavity, cut again the protruding part, and so forth, until the retainer member is completely removed.

Embodiments are conceivable in which at least one retainer cavity and a retainer member disposed therein are tapered in one direction. It is apparent, that in this case the pushing force on the retainer member must be applied from the side with the narrower cross section, and displacement consequently needs to appear against the tapering direction.

It is noted that by virtue of the herein disclosed subject matter an accordingly provided blading member may be disassembled without the need to substantially damage any of the airfoil member and the blading member. It is further noted that all access ports are provided within the receiver cavity, or at a joint interface of the platform member and the airfoil member fixation post. No access port at a side of the platform needs to be provided, into which high temperature working fluid might otherwise be ingested. This is particularly notable, as ingestion of high temperature fluid into a cavity in which an in-situ prepared retainer member is provided may cause substantial harm to the interlock between the blading member and the platform member. It is also particularly notable that it is disclosed to be able to remove the retainer member through a space which may be insufficient to remove the retainer member in one piece. This in turn means that it would be impossible to insert a retainer member through the space provided. This is enabled in preparing the retainer member in situ by a molding or casting process, as repeatedly referred to above.

It is, however, conceivable, if a blading member which is provided without the mentioned access ports, that is, for instance, a blading member according to the art, in which an in situ prepared retainer member is provided as a single closed clip, may be disassembled in removing material from the collar, and the fixation post. All these steps can be performed from the coolant side of the blading member which is considerable less thermally loaded than the working fluid exposed side. Thus, access ports as shown in FIGS. 1 and 2 at reference numerals 51, 52, 53 and 54 are prepared, and the retainer member may be removed as described above. As all the damage to the airfoil member and the platform member is done at the coolant side, the respective members may be reused after, if needed, having been appropriately reconditioned.

In FIG. 3 a first exemplary mode of preparing and removing a retainer member in a retainer cavity, and accordingly also a method for assembling a blading member as herein disclosed, is figured in a much schematic depiction. The member denoted by reference numeral 6 figures any physical embodiment in which a retainer cavity 61 is provided. Said member may for instance be jointly provided by an airfoil member and a platform member, as lined out in connection with FIGS. 1 and 2. A mold access port 62 is provided in member 6 and in connection with retainer cavity 61. Open front faces of retainer cavity 61 are sealed by retractable closure members 7 during in situ preparation of a retainer member inside retainer cavity 61, in order to enclose a liquid casting slip which is molded into retainer cavity 61 through mold access port 62 during the molding process. After the liquid casting slip is solidified, retractable closure ports 7 may be removed. An in situ prepared retainer member 4 remains inside the retainer cavity. A pimple 45 formed on retainer member 4 remains inside the mold access port, providing a form lock feature and securing retainer member 4 against axial displacement during service. Further form lock elements may be provided, but need to be removed upon removal of retainer member 4 from the retainer cavity, as lined out below. Retainer member 4 may be removed in removing pimple 45, or any other form lock feature or element provided, for instance by milling, and applying a pushing force 8 on one end of retainer member 4 through an open front face of retainer cavity 61, thus displacing retainer member 4 along the lengthwise extent of retainer cavity 61 and out of the other open front face of the retainer cavity. A predetermined breaking point between the pimple and/or any other form lock feature provided, and retainer member 4 may be provided, for instance, in that mold access port 62 is provided with a neck at the joint with retainer cavity 61. Retainer member 4 may then be removed without prior removal of pimple 45, if sufficient pushing force can be applied on the retainer member to break the connection between the pimple and the retainer member at the predetermined breaking point.

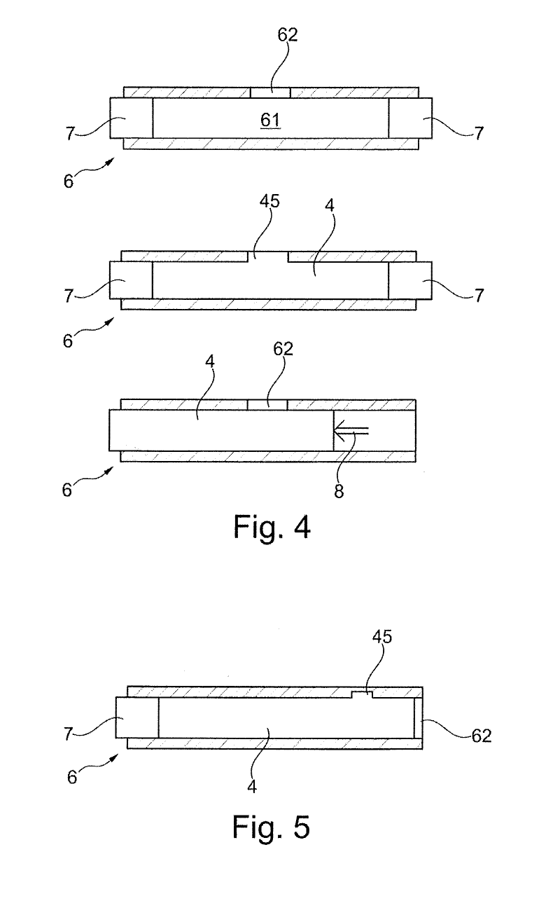

In another mode of preparing and removing a retainer member figured in FIG. 4, end plugs 7 are provided in the open front faces of retainer cavity 61. Said end plugs may for instance be threaded bolts or spot welded pins. Retainer member 4 is, as lined out above, prepared in molding a liquid casting slip into retainer cavity 61 through mold access port 62, and solidifying the liquid casting slip inside the retainer cavity. End plugs 7 may remain inside retainer cavity during service. Upon removal of retainer member 4, end plugs 7 are removed, for instance in driving out threaded bolts on milling spot welds. Pimple 45 formed on retainer member 4 in mold access port 62 may be removed appropriately. In applying a pushing force 8 at one end of retainer member 4, retainer member 4 may be displaced out of the retainer cavity.

In the embodiment shown in FIG. 5, only one open front face of the retainer cavity is sealed by an end plug 7 during the molding process. The mold access port may then be provided by the other open front faces of the retainer cavity which is left open. An undercut may be provided on a wall of the retainer cavity, to form a form lock feature 45 on retainer member 4 and to to lock retainer member 4 against axial displacement inside the retainer cavity during service. By virtue of the explanations provided above, the skilled person will fully appreciate how retainer member 4 may be removed in this embodiment.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 turboengine component, turboengine blading member
2 received member, blading member
3 receiving member, platform member
4 retainer member
6 physical embodiment
7 closure member, end plug
8 pushing force
21 fixation post
22 body of received member, airfoil
31 collar
32 working fluid exposed side of receiving or platform member
33 coolant side of receiving or platform member
41 retainer member
42 retainer member
43 retainer member
44 retainer member
45 pimple, form lock feature
51 space, access port
52 space, access port
53 space, access port
54 space, access port
61 retainer cavity
62 mold access port

1. A turboengine component, comprising:
at least one first, receiving, member; and
at least one second, received, member, the receiving member having at least one receiver opening, the received member having a body and at least one fixation post extending from said body, the fixation post being received in a receiver opening of the receiving member and forming a joint with the receiving member inside the receiver opening, wherein at least one retainer cavity is formed at the joint, the retainer cavity including at least one first retainer groove provided at an inner surface of the receiver opening and at least one second retainer groove provided on a surface of the fixation post, said retainer cavity having a cross section and a lengthwise extent; and
a retainer member provided in the retainer cavity, the retainer member having a cross section and a longitudinal extent, wherein the longitudinal extent of the retainer member is aligned with the lengthwise extent of the retainer cavity, wherein further the retainer cavity is open at two front faces and the lengthwise extent extends between said two open front faces and is arranged and configured such that the retainer member is displaceable within the retainer cavity along the lengthwise extent, the open front faces of the retainer cavity being provided at the joint of the fixation post and the receiving member.

2. The turboengine component according to claim 1, wherein the fixation post and the receiver opening are arranged and configured such as to allow access to the front faces of the retainer cavity from within the receiver opening, and wherein a space is provided inside the receiver opening adjacent at least one of the front faces, which enables the retainer member to be displaced from the retainer cavity into said space by a displacement along the lengthwise extent.

3. The turboengine component according to claim 1, wherein the lengthwise extent of the retainer cavity extends along one of an at least essentially straight or circular line.

4. The turboengine component according to claim 1, wherein at least one of the retainer cavity and the retainer member tapers unidirectionally along the lengthwise or longitudinal extent, respectively.

5. The turboengine component according to claim 1, wherein the retainer member is locked inside the retainer cavity.

6. The turboengine component according to claim 5, wherein the locking engagement is provided by a form lock feature.

7. The turboengine component according to claim 1, wherein each cross section of the retainer member exactly matches a corresponding cross section of the retainer cavity in which it is disposed along the entire longitudinal extent of the retainer member such that the retainer member snugly fits inside the retainer cavity.

8. The turboengine component according to claim 1, wherein at least one mold access port is provided in communication with the retainer cavity, the mold access port being arranged between the front faces of the retainer cavity and transverse to the retainer cavity lengthwise extent, such as to allow the retainer member to be prepared in situ by a mold process inside the retainer cavity.

9. The turboengine component according to claim 1, wherein at least two retainer cavities with retainer members provided therein are provided at the joint of the fixation post and the receiving member inside the receiver opening.

10. The turboengine component according to claim 1, wherein at least two retainer cavities with a retainer member provided therein are disposed on opposite sides of the fixation post.

11. The turboengine component according to claim 1, where at least two retainer cavities with retainer members provided therein are disposed at the joint of the fixation post and the receiving member inside the receiver opening, wherein said at least two retainer cavities are provided with the respective cross sections offset with respect to one another on an inner wall of the receiver opening and on the fixation post in a direction across the lengthwise extent of a retainer cavity, such that the cross sections of said retainer cavities are provided without a cross sectional overlap.

12. The turboengine component according to claim 1, wherein a multitude of retainer cavities with retainer members provided therein are provided at the joint between the fixation post and the receiving member inside the receiver opening, wherein each pair of neighboring retainer cavities are provided with the respective cross sections offset with respect to one another on an inner wall of the receiver opening and on the fixation post along a direction oriented across the lengthwise extent of a retainer cavity, such that the cross sections of each pair of neighboring retainer cavities are provided without a cross sectional overlap.

13. A method of reconditioning a turboengine component, the turboengine component having at least one first, receiving, member and at least one second, received, member, the receiving member having a receiver opening, the received member having a body and at least one fixation post extending from said body, the fixation post being received in a receiver opening and forming a joint with the receiving member inside the receiver opening, wherein at least one retainer cavity is formed at the joint, the retainer cavity including at least one first retainer groove provided at an inner surface of the receiver opening and at least one second retainer groove provided on a surface of the fixation post, said retainer cavity having a cross section and a lengthwise extent, and a retainer member is provided in the retainer cavity, the retainer member having a cross section and a longitudinal extent, wherein the longitudinal extent of the retainer member is aligned with the longitudinal extent of the retainer cavity, the method comprising:
accessing an open front face of a retainer cavity provided inside the receiver opening and accessing the open front face from within the receiver opening;
applying a pushing force on the retainer member from said open front face of the retainer cavity (61), thus displacing the retainer member inside the retainer cavity and at least partially out of the retainer cavity at a second open front face of the retainer cavity; and
removing the retainer member, and disassembling the receiving member and the received member.

14. The method according to claim 13, comprising:
applying a material removing process at the joint between the received member and the receiving member, thus preparing an opening of the retainer cavity and providing an open front face of the retainer cavity inside the receiver opening.

15. The method according to claim 13, comprising:
providing at least one of a received member and a receiving member;
providing a matching other one of a received member and a receiving member;
assembling the receiving member and the received member in inserting a fixation post of the received member into a mating receiver opening of the receiving member;
matching at least one retainer groove provided inside the receiving member receiver opening with at least one retainer groove provided on the received member fixation post such as to form a retainer cavity, said retainer cavity in particular including two front faces and a lengthwise extent extending between said two open front faces;
molding a liquid casting slip into the retainer cavity; and
solidifying the casting slip inside the retainer cavity, thus manufacturing a retainer member inside the retainer cavity in situ.
